(19) United States
(12) Patent Application Publication
(10) Pub. No.: US 2023/0397617 A1
(43) Pub. Date: Dec. 14, 2023

(54) HYPODERMIC INJECTION NEEDLE AND SYSTEMS AND METHODS INCLUDING THE SAME

(71) Applicant: John Bean Technologies Corporation, Chicago, IL (US)

(72) Inventor: Dale R. Hunt, Sandusky, OH (US)

(73) Assignee: John Bean Technologies Corporation, Chicago, IL (US)

(21) Appl. No.: 18/326,366

(22) Filed: May 31, 2023

Related U.S. Application Data
(60) Provisional application No. 63/366,208, filed on Jun. 10, 2022.

(51) Int. Cl. A22C 17/00

(52) U.S. Cl. CPC A22C 17/0053

(57) ABSTRACT

In some aspects, the systems and devices described herein relate to an injection needle for injecting fluid into a substrate such as a food product, including: an elongated hollow shank having a center longitudinal axis, an inner shank wall, and an outer shank wall; and a needle tip, including: an injection opening; and a curved end portion extending from the elongated hollow shank and having a radius of curvature, the curved end portion terminating distally in a bottom outer edge and a cutting face extending from the bottom outer edge toward the inner shank wall at a bottom end of the injection opening, wherein the bottom outer edge and the cutting face are in substantially vertical alignment with an axis of a first portion of the inner shank wall extending from a top end of the injection opening.

### CROSS-REFERENCE TO RELATED APPLICATION

This application claims the benefit of U.S. Provisional Application No. 63/366,208, filed Jun. 10, 2022, the entire contents of which application are incorporated herein by reference.

### BACKGROUND

Meat processing operations include a wide variety of processing steps for preparing meat products for consumers. After slaughter, the animal carcass is cleaned, chilled, and then passed on to trimming operations in which large cuts of meat such as steaks, roasts, and filets are separated from the carcass. Special processing steps may be applied to the material left after the initial trimming operations to recover additional lean meat from the trimmings. Corresponding operations may be used to process other types of protein, such as fish and poultry (hereinafter sometimes collectively referred to a “product” or “food product”).

One common downstream treatment process includes injecting various liquids into the food product. The liquids may include flavor enhancing agents, microbe suppression agents, color enhancing agents, curing agents or liquids for otherwise imparting certain desired characteristics to the food product. Regardless of the purpose of the injected liquid, a liquid injected into a food product is commonly referred to as a “brine,” “pickle,” “marinade,” “emulsion,” or the like (hereinafter sometimes collectively referred to throughout as an “injection fluid” or similar).

Brine injecting, for example, can be done using a brine injection machine that can be as simple as a small portable brine pump connected to a large syringe to industrial brining systems that have a head or multiple heads filled with hypodermic or side port needles injection needles. Industrial brining systems may be used to carry out a brining process including one or more of the following steps: (1) product placement on an infeed conveyor; (2) movement of the food product beneath the injection head (typically using a walking beam system or some type of conveyor belt system); (3) downward movement of the needles (via the head) to penetrate the needles into the product as the product moves along the processing path; (4) pumping of brine from a container (from a brine tank or other brine system) through the needles into the product; (5) retracting the needles from the product by moving the head upward; (6) movement of the product toward a machine exit for further processing or packaging. These brining steps may be accomplished by different methods depending on the type of brine injector used, the food product being processed, the throughput required, etc.

Aspects of the present disclosure are directed to improved injection systems including the hypodermic injection needles used with the systems.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In some aspects, the systems and devices described herein relate to an injection needle for injecting fluid into a substrate such as a food product, including: an elongated hollow shank having a center longitudinal axis, an inner shank wall, and an outer shank wall; and a needle tip, including: an injection opening; and a curved end portion extending from the elongated hollow shank and having a radius of curvature, the curved end portion terminating distally in a bottom outer edge and a cutting face extending from the bottom outer edge toward the inner shank wall at a bottom end of the injection opening, wherein the bottom outer edge and the cutting face are in substantially vertical alignment with an axis of a first portion of the inner shank wall extending from a top end of the injection opening.

In some aspects, the systems and devices described herein relate to a system for injecting fluid into a substrate such as a food product, including: a needle carrier configured to receive injection fluid from a fluid source; an injection needle received within the needle carrier, including: an elongated hollow shank having a center longitudinal axis, an inner shank wall, and an outer shank wall; and a head configured to receive a plunging force from the needle carrier; and a needle tip, including: an injection opening; and a curved end portion extending from the elongated hollow shank and having a radius of curvature, the curved end portion terminating distally in a bottom outer edge and a cutting face extending from the bottom outer edge toward the inner shank wall at a bottom end of the injection opening, wherein the bottom outer edge and the cutting face are in substantially vertical alignment with an axis of a first portion of the inner shank wall extending from a top end of the injection opening.

In some aspects, the methods described herein relate to a method for injecting fluid into a substrate such as a food product, including: communicating fluid to a needle carrier; allowing fluid to flow into an inlet opening of an elongated hollow shank of an injection needle received within the needle carrier; inserting a tip of the injection needle into a substrate; shielding an injection opening at the tip to substantially prevent substrate from entering the injection opening; and guiding fluid flow out of the injection opening at an angle relative to a center longitudinal axis of the elongated hollow shank.

### DESCRIPTION OF THE DRAWINGS

The patent or application file contains at least one drawing/photograph executed in color. Copies of this patent or patent application publication with color drawing(s) will be provided by the Office upon request and payment of the necessary fee.

The foregoing aspects and many of the attendant advantages of this invention will become more readily appreciated as the same become better understood by reference to the following detailed description, when taken in conjunction with the accompanying drawings, wherein:

FIG. 1 illustrates a needle carrier used to carry injection needles of the present disclosure.

FIG. 2 is an elevational view of an exemplary embodiment of an injection needle in accordance with the present disclosure.

FIG. 3 is an enlarged fragmentary view of a portion of the needle of FIG. 2.

FIG. 4 is an enlarged fragmentary view of a portion of the needle of FIG. 2.

FIG. 5 is an enlarged cross-sectional view of FIG. 4 taken along lines thereof.

FIG. 6 is a cross-sectional view of FIG. 4 similar to FIG. 5, illustrating an alternative cross-sectional view.

FIG. 7 is a cross-sectional view of a needle tip of a first example of a prior art injection needle.

FIG. 8 is an enlarged, fragmentary view of a needle tip of a second example of a prior art injection needle, shown partially in cross-section.

FIG. 9 is an enlarged, fragmentary view of a portion of the needle of FIG. 2, shown in cross-section.

FIG. 10 is an enlarged, fragmentary view of a portion of the needle of FIG. 2, shown partially in cross-section.

FIG. 11 is a photograph showing a plurality of needles formed in accordance with exemplary embodiments of the present disclosure with fluid exiting an injection opening.

FIG. 12 is a photograph showing a plurality of food products injected with a brine containing dye using the injection needles of the present disclosure.

FIG. 13 is a photograph showing a close-up view of a food product injected with a brine containing dye using the injection needles of the present disclosure.

FIG. 14 is a photograph showing a plurality of food products injected with a brine containing dye using prior art injection needles.

FIG. 15 is a photograph showing a close-up view of a food product injected with a brine containing dye using prior art injection needles.

FIG. 16 is a photograph comparing a first food product injected with a brine containing dye using the injection needles of the present disclosure and a second food product injected with a brine containing dye using prior art injection needles.

### DETAILED DESCRIPTION

The description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result.

In the following description, numerous specific details are set forth in order to provide a thorough understanding of exemplary embodiments of the present disclosure. It will be apparent to one skilled in the art, however, that many embodiments of the present disclosure may be practiced without some or all of the specific details. In some instances, well known process steps have not been described in detail in order not to unnecessarily obscure various aspects of the present disclosure. Further, it will be appreciated that embodiments of the present disclosure may employ any combination of features described herein.

In the following description and in the accompanying drawings, corresponding systems, assemblies, apparatus, and units may be identified by the same part number, but with an alpha suffix or by using the same reference number in a different '100 series. The descriptions of the parts/components of such systems assemblies, apparatus, and units that are the same or similar are not repeated so as to avoid redundancy in the present disclosure.

The present disclosure may include references to “directions,” such as “top,” “bottom,” “inner,” “outer”, “forward,” “rearward,” “front,” “back,” “ahead,” “behind,” “upward,” “downward,” “above,” “below,” “horizontal,” “vertical,” “right hand,” “left hand,” “in,” “out,” “extended,” “advanced,” “retracted,” “proximal,” “distal,” etc. These references and other similar references in the present disclosure are only to assist in helping describe and understand the present disclosure and are not intended to limit the present invention to these directions.

The present disclosure may include modifiers such as the words “generally,” “approximately,” “about,” or “substantially.” These are meant to serve as modifiers to indicate that the “dimension,” “shape,” “temperature,” “time,” or other physical parameter in question need not be exact, but may vary as long as the function that is required to be performed can be carried out. For example, in the phrase “generally circular in shape,” the shape need not be exactly circular as long as the required function of the structure in question can be carried out.

In the present disclosure the terms “substrate,” “material,” “protein,” “food product,” “product, and the like may be used interchangeably and should not be seen as limiting. Further, the terms “injection fluid”, “fluid”, “brine,” “pickle”, “marinade,” “emulsion,” and the like may be used interchangeably and should not be seen as limiting. It will be appreciated that the injected liquid need not in fact include a salt or any other material in solution to qualify as an “injection fluid” under the broad definition as used in this disclosure and the accompanying claims.

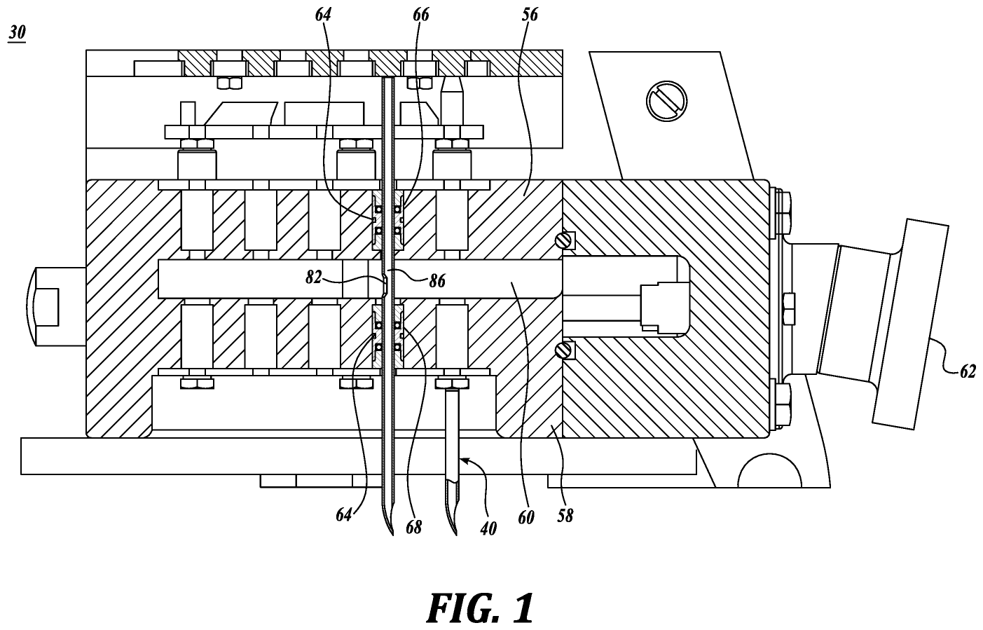

FIG. 1 depicts an exemplary injection head or needle carrier 30 of an industrial brining system (not shown). The needle carrier 30 may be adapted for use with any suitable industrial or manual brining system, machine, or device; and therefore, the needle carrier 30 shown and described herein should not be seen as limiting.

In general, the needle carrier 30 is configured to move a plurality of injection needles 40 into and out of engagement with a food product for injecting a brine or other liquid into the product. In that regard, the needle carrier 30 may be moveable in a z-direction for injecting the product and withdrawing from the product. The needle carrier 30 may also be moveable laterally (in an x- and y-direction) by a gantry or other structure for locational placement of the injection needles in the food product. Instead, the needle carrier 30 may be stationary or may move only laterally and may apply a plunging force to any injection needles received therein.

The needle carrier 30, as shown in FIG. 1, includes a carrier upper section 56 and a carrier lower section 58 to define a feeder supply chamber 60 therebetween. An inlet port 62 connects the supply chamber 60 to a brine container or other storage tank (not shown).

A plurality of injection needles 40 are supported by the carrier 30. In this regard, seal rings 64 are disposed within counter bores 66 and 68 extending downwardly into the carrier upper section 56 and upwardly into the carrier lower section 58. The seal rings 64 are retained within the counter bores 66 and 68 to closely receive needles 40.

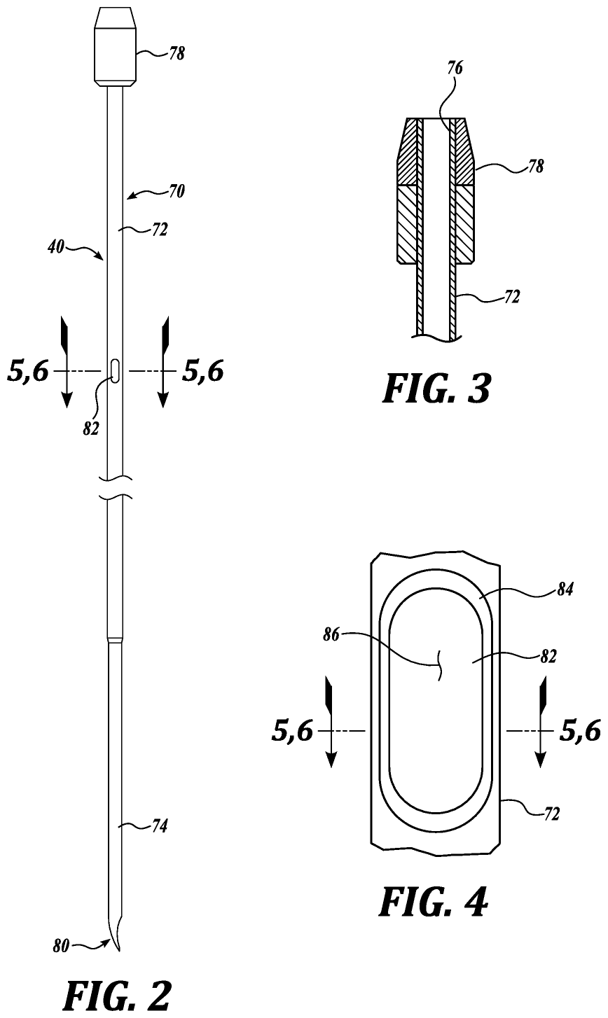

Referring to FIGS. 2 and 3, each injection needle 40 includes a cannula or an elongated hollow shank 70 having a hollow interior 86 extending along its length. The elongated hollow shank 70 is made in a manner well known in the art from a suitable material, such as hypodermic stainless steel or another alloy. For instance, the elongated hollow shank 70 may be made using a CNC automated process. The elongated hollow shank 70 includes an upper end 76 defined opposite a needle tip 80. The upper end 76 is securely engaged within an inner diameter of a head 78. The head 78 is constructed to receive the plunging force used to insert the needle tip 80 into the food product being processed.

Referring specifically to FIG. 2, the elongated hollow shank 70 includes an upper shank section 72 that is larger in outer diameter than a lower shank section 74. In one nonlimiting example, the upper shank section 72 may have a gauge or outer diameter in the range of 2.5-5 mm, and the lower shank section may have an outer diameter of 2-2.5 mm. As a more specific example, the hollow shank 70 could be constructed with an upper shank section 72 having a 3.0 mm outer diameter and a lower shank section 74 with a 2.5 mm outer diameter. The enlarged upper shank section 72 enables brine to enter the needle sufficiently quickly (such as through inlet opening 82, described below) to keep the needle filled with brine during the injection process. On the other hand, the reduced diameter lower section 75 enables suitable penetration of the needle 40 into the food product. The upper and lower shank sections 72 and 74 may both have the same inside diameter suitable for injection, such as about 1.5 mm.

Referring to FIGS. 2 and 4, an inlet opening 82 is formed in the upper shank section 72 so as to be in registry with the supply chamber 60 for filling the hollow interior 86 of the needle 40 with brine during the injection process. Although only a single inlet opening 82 is illustrated, more than one inlet opening can be employed.

In the depicted exemplary embodiment, the inlet opening 82 is elongated and extends along a portion of the length of the upper shank section 72. The inlet opening 82 is shown as generally an elongated oval shape, although any other shape that allows for suitable filling of the injection needle 40 may instead be used.

The inlet opening 82 also has a size configured to allow for suitable filling of the injection needle 40. As a non-limiting example, the length of the opening may be from about 5 mm to about 10 mm. Correspondingly, as a nonlimiting example, the width of the opening can be from about 2 mm to about 4 mm. In one specific example, the size of the opening 82 is about 7 mm in length and 2.5 mm in width. Of course, these dimensions may be increased or decreased in size depending, for instance, on the characteristics of the needle shank (e.g., inner/outer diameter, material, etc.) and/or the type of liquid (e.g., brine v. emulsion) being injected.

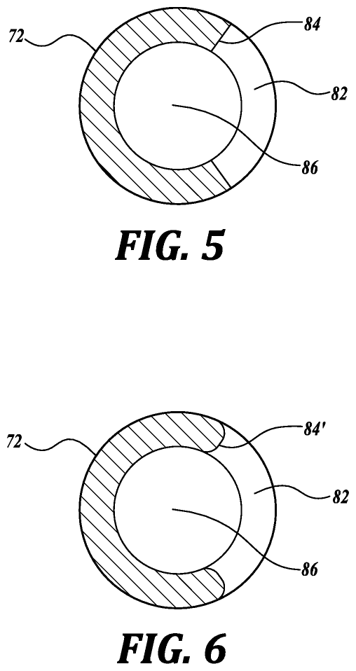

As shown in FIGS. 4 and 5, an edge 84 surrounding the inlet opening 82 may be tapered or beveled outwardly from the hollow interior 86 to an exterior surface of the elongated hollow shank 70. The bevel angle can be of various degrees, for example, from about 30° to 60°. As a specific nonlimiting example, the bevel angle can be about 45°.

As another example, the edge 84′ surrounding the inlet opening 82 can be radiused or curved rather than in the form of a bevel, as shown in FIG. 6. The curvature may extend across the entire wall thickness of the inlet opening 82 as shown or the curvature may be limited to the intersection of the edge 84 and the outer surface of the elongated hollow shank 70.

By beveling or curving the edge 84 of the inlet opening 82, components of the mixture flowing into the inlet opening 82 may have less tendency to build up at the inlet opening 82. For instance, if the inlet opening 82 is defined by a straight cut into the elongated hollow shank 70 rather than having a beveled or curved edge 84, components of the injection fluid (such as any emulsification, especially solid material or fat or gelatinous material) will tend to build up at the inlet opening 82, including at the corner of the opening. Over time, buildup of such material can significantly reduce the size of the inlet opening 82 or even cause the inlet opening to close all together. However, by beveling or curving the inlet opening 82, as shown in FIGS. 5 and 6, and as described above, there is less likelihood that the injected materials will collect or build up at the inlet opening.

As noted above, upon receiving a plunging force, the needle tip 80 of the injection needle 40 is inserted into the food product being processed. A needle tip has a sharp point to pierce the food product that is typically aligned with the shank elongated center axis. One or more sharp cutting edges may also be defined at the needle tip, such as by cutting the tube at an angle in one or more portions defining the tip. Finally, at least one injection opening is defined near or at the tip to deliver the injection fluid into the product when inserted.

Certain food products like bacon and plant-based meats have a hardness greater than other products that are injected, such as other meat products (such as hams and the loin portion or back of pork and other nonpoultry meats such as lamb, veal or beef), fish, poultry, etc. Bacon includes a layer of fat that, when cold, is relatively hard. Current types of plant-based material are relatively hard throughout due to their material properties. Injecting hard substrates like bacon and plant-based meats can cause bottom injection opening(s) (e.g., an exit opening defined at a bottom tip of the needle) to plug or core. As a specific example, hard pork back fat can core up a bottom injection opening of the needle during injection. Prior art injection systems may use a “side port exit tip” needle design (also sometimes called a “pencil point” design) to minimize plugging or coring at the tip.

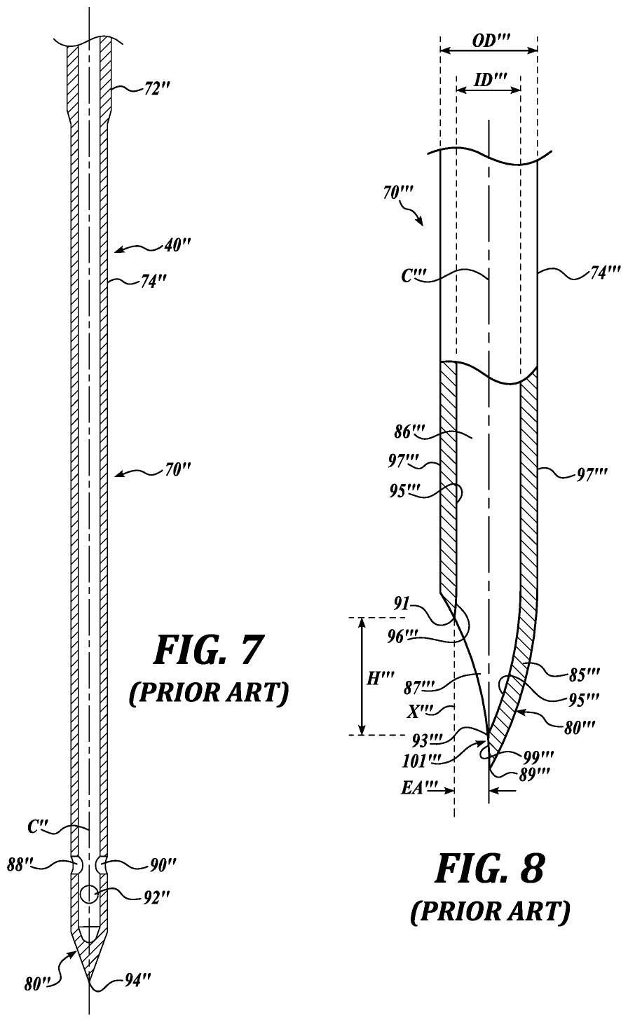

A prior art side port exit tip design is shown in FIG. 7. The elongated hollow shank 70″ includes a needle tip 80″ having side port exit holes 88″, 90″, and 92″ defined in the sidewall of the shank 70″ and spaced upwardly from a bottom point 94″ of the tip that is aligned with the shank elongated center axis C″. The side port exit holes 88″, 90″, and 92″ are typically located on the shank 70″ about 6 to 7 mm upwardly from the bottom point 94″. Such hole location can be very effective at injecting the fluid laterally into the product. However, certain food products, such as plant-based meats are only about 12 mm thick. Accordingly, by using a needle having side port exit holes located on the shank 70″ about 6 to 7 mm upwardly from the bottom point 94″, only an upper portion of the plant-based sheet material would be injected with fluid. In that regard, a needle having an opening at the bottom tip of the needle (e.g., adjacent the tip or sharpened point of the needle) may be preferred.

Various types of needle designs having an opening at the bottom tip of the needle, such as a standard 45° beveled needle point (or other angles typically between) 12-60°, a lancet point needle, a semi-lancet point needle, a back cut point needle, etc., would be suitable to deliver fluid into lower portions of the food product. In each case, the injection opening is defined at the bottom of the needle, often by cutting the tube defining the elongated shank an angle to define an opening. The angled tip defines the sharpened end for piercing the substrate, and the opening defined by the angled cut allows liquid to exit downwardly (substantially along the elongated shank axis) from the needle. However, fluid flow in a substantially straight downward direction may not be desirable for effectively dispersing the injection fluid, such as brine, into a food product.

A “rolled tip” design has been used to help guide the flow of injection fluid into the substrate at least somewhat laterally while still using a bottom opening. A prior art rolled needle tip 80′″ is shown on the elongated hollow shank 70′″ of FIG. 8, which may be formed from a straight metal tube having an outer diameter OD′ of about 2.2-2.5 mm and an inner diameter ID′ between about 1-2 mm. The rolled needle tip 80′″ includes a curved end portion 85′″ a bottom injection opening 87′″. The rolled needle tip 80′″ can be formed, for instance, by rolling a straight metal tube at its distal tip using well known manufacturing methods and thereafter cutting the tube to define the injection opening 87′″.

The straight metal tube can be rolled to define a predetermined radius of curvature for the curved end portion 85′″ as shown. In general, the radius of curvature for the curved end portion 85′″ is configured to define a bottom outer edge 89′″ of the tip 80′″ that is substantially aligned with the shank elongated center axis C′″. At the same time, the radius of curvature is configured to define a predetermined injection opening height H′″ between upper and bottom inner edges 91′″ and 93″, respectively, of the injection opening 87′″ (which may be dependent on the type of cut used to form the injection opening 87′″). For instance, in the example shown, the injection opening height H′″ is about 2.4 mm for a needle formed from a straight metal tube having an outer diameter OD′″ of about 2.2 mm.

After rolling the end of the tube, the tube may be cut to define the injection opening 87′″ and an injection opening cutting face(s) 101′″ surrounding the injection opening 87″′. The injection opening cutting face(s) 101′″ extends between a shank interior surface or sidewall 95′″ and a shank exterior surface or sidewall 97″′. The cut into the rolled tube may be a curved cut defining the injection opening cutting face(s) 101″′ having a radius of curvature. In the depicted prior art embodiment, the injection opening cutting face(s) 101′″ has a radius of curvature to define a substantially vertical lower cutting planar surface 99′″ extending between the shank sidewalls at the bottom outer edge 89′″ of the tip 80″′. The lower cutting planar surface 99″′ and the bottom outer edge 89′″ are substantially aligned with the shank elongated center axis C′″.

As can be appreciated by referring to FIG. 8, any fluid traveling down the hollow interior 86′″ of the elongated hollow shank 70′″ along the curved end portion flows at least somewhat laterally out of the injection opening 87″′. In other words, the fluid flows out of the opening at an angle relative to the shank elongated center axis C′″. Accordingly, better dispersion of injection fluid into a food product can be achieved using the prior art rolled tip design shown in FIG. 8 compared to the side port exit design shown in FIG. 7.

However, in the prior art “rolled tip” design shown in FIG. 8, as well as the other prior art bottom tip opening needle designs, the injection opening tends to plug or core when inserted into harder substrates like bacon fat and plant-based meats. In each of these designs, the sharp needle point used to pierce the food product is aligned with the shank elongated center axis. Although alignment of the sharp needle point with the shank elongated center axis enables effective piercing when moving the needle in a straight downward direction, the injection fluid opening (such as opening 87′″) is at least somewhat exposed toward the bottom of the needle such that food product can enter the fluid opening upon insertion.

More specifically, an exposed area EA′″ of the injection opening 87′″ is defined by the vertically offset relationship of the upper and bottom inner edges 91′″ and 93″′, respectively, of the injection opening 87′″. In that regard, the exposed area EA″′ extends between an axis X′″ extending along the length of the shank interior sidewall 95′″ and the shank elongated center axis C. When the needle is moved in a straight downward direction for injection, material from the food product can enter the injection opening 87′″ in the exposed area EA′″.

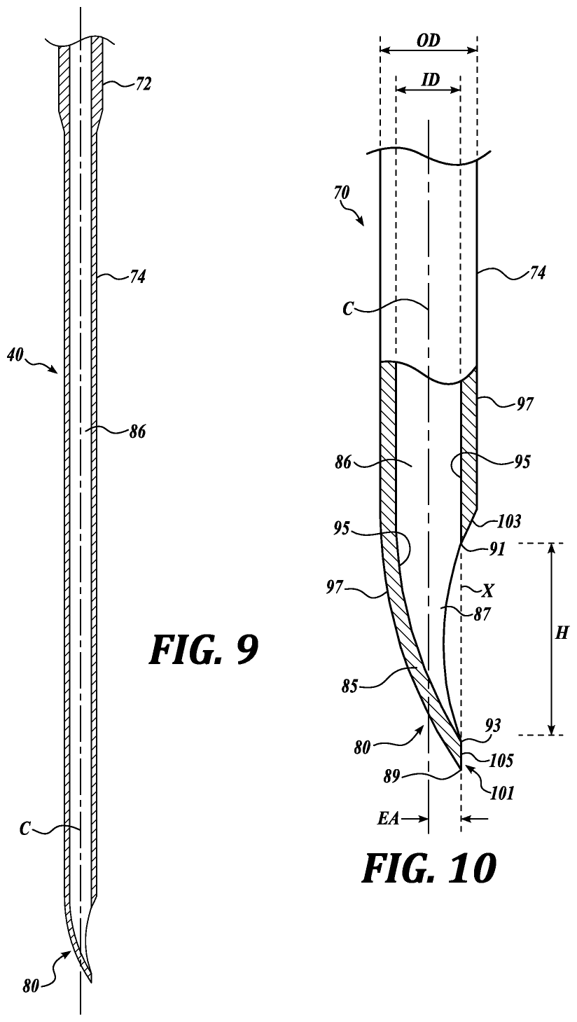

FIGS. 9 and 10 depict an exemplary embodiment of an improved needle tip 80 that directs injection fluid out of the injection opening for optimal dispersion into the food product (including a bottom portion of the food product) while also substantially preventing plugging or coring at the injection opening. The needle tip 80 is also shown on the injection needle 40 in FIGS. 1 and 2.

In general, the needle tip 80 includes a rolled tip end that extends past the shank elongated center axis C to substantially prevent plugging or coring at the injection opening. In other words, the tube is rolled and then cut past the shank elongated center axis C. As will become better appreciated below, rolling and cutting the tube past the shank elongated center axis C allows a curved end portion 85 of the tip to effectively shield the injection opening 87 from food product during needle insertion. At the same time, the needle tip 80 is configured to effectively pierce a food product and direct fluid flow out of the injection opening in a desired direction, e.g., at an angle relative to the shank elongated center axis C. Further, the needle tip 80 can reach and inject into a bottom portion of a food product, such as a bottom half of a food product having a height or thickness of about 12 mm. These aspects will become better appreciated from the descriptions that follow.

The improved needle tip 80 includes a curved end portion 85 having an injection opening 87. The curved end portion 85 may be formed by rolling a straight metal tube used to form the lower shank section 74 of the elongated shank 70, which, as described above, may have an outer diameter OD′ of about 2-2.5 mm and an inner diameter ID′″ between about 1-2 mm, such as about 1.5 mm.

The straight metal tube is rolled to define a predetermined radius of curvature for the curved end portion 85. The radius of curvature for the curved end portion 85 may be selected or defined based on at least one of the following factors: (1) the curvature needed to direct fluid out of the injection opening 87 at a desired flow rate and/or a desired angle relative to the shank elongated center axis C; (2) the desired shape and configuration (e.g., size, beveled edges, and/or radius of curvature) of the injection fluid opening 87 and its surrounding face(s)/edge(s); (3) the type of injection fluid being used; and (4) the type of food product being injected. Other factors may also be considered. In an example, the radius of curvature for the curved end portion 85 is configured to define a curvature of the needle of about 40°, which can be used to effectively inject hard food products (like bacon and plant-based meats) with an injection fluid, such as a brine generally composed of water, salt, flavors, starch, gums meat protein, cure, erythorbate, phosphate sweeteners, antimicrobials, etc.

In an exemplary embodiment, the radius of curvature for the curved end portion 85 may be defined such that fluid exiting the injection opening 87 flows at a desired flow rate for optimal dispersion into the food product. The flow rate will depend on the type of fluid used (e.g., a less viscous fluid may flow out of the injection opening 87 faster than a more viscous fluid). For instance, the radius of curvature for the curved end portion 85 is defined such that an injection fluid (e.g., a brine generally composed of water, salt, flavors, starch, gums meat protein, cure, erythorbate, phosphate sweeteners, antimicrobials, etc.) exiting the injection opening 87 flows at a predefined rate for achieving optimal dispersion of fluid into the product when the needle tip 80 is removed from the substrate, such between about 0.75 to 1.5 gallons/minute depending on injection fluid viscosity.

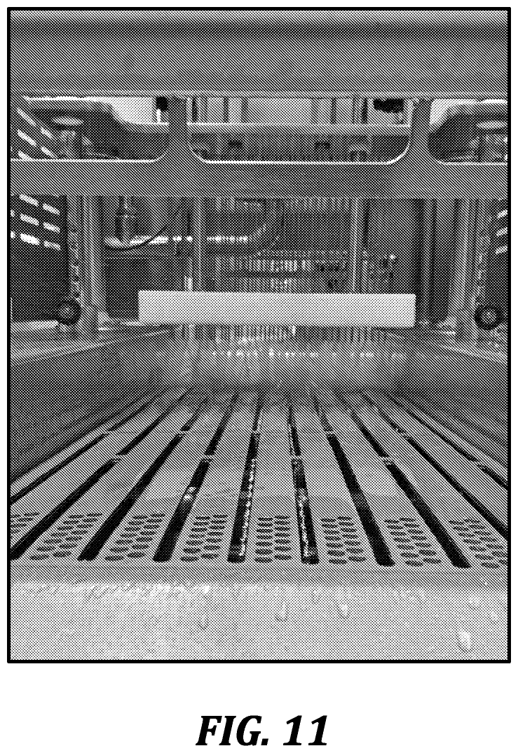

In an exemplary embodiment, the radius of curvature for the curved end portion 85 may be defined such that any fluid exiting the injection opening 87 is at a desired angle relative to the shank elongated center axis C. Fluid flowing through the hollow interior 86 down into the needle tip 80 is guided by the curved path of the shank interior sidewall 95 along the curved end portion 85 until it exits the injection opening 87. The radius of curvature for the curved end portion 85 may be defined such that fluid exiting the injection opening 87 is at a substantially 40° angle relative to the shank elongated center axis C when the needle tip 80 is removed from the substrate. For instance, the picture shown in FIG. 11 shows the fluid exiting the injection opening 87 at a substantially 40° angle.

In this manner, the fluid is directed at least somewhat laterally into the food product. At the same time, the fluid may flow at least somewhat downwardly into the injected substrate after exiting the injection opening 87. In one example, optimal dispersion is achieved when the fluid flows laterally into the food product at least about 5 to 10 mm and optionally downwardly into the food product to about the bottom of the food product.

The optimized angle of fluid exit can help disperse brine into pork belly to produce bacon. In the processing of pork bellies to produce bacon, a brine is typically injected into the pork belly which contains components for both curing and flavoring the bacon resulting from the pork belly. The optimized fluid exit angle defined by the radius of curvature of the curved end portion 85 enables better dispersion of the solution in the belly when compared to injecting with a prior art rolled tip such as the tip 80′″ shown in FIG. 8, resulting in one or more of the following: (1) more even cure or salt dispersion; (2) more even cure color; and (3) better brine retention.

The optimized angle of fluid exit can also help accentuate meat fiber appearance in plant-based substrates. Plant-based sheet material may include generally horizontal layers of substrate. When the fluid is injected at the angle defined by the radius of curvature of the curved end portion 85, fluid can be delivered into or between the layers of the plant-based sheet material.

As noted above, the tube is rolled and then cut past the shank elongated center axis C. In the depicted exemplary embodiment, the tube is rolled and then cut such that a bottom inner edge 93 of the injection opening 87 is substantially vertically aligned with an elongated axis X of the shank interior sidewall 95 on the side of the shank 70 opposite the curved end portion 85. As such, the curved end portion 85 effectively has an extended or longer arc length compared to the prior art design. A longer curved end portion 85 can improve the flow rate of the injection fluid exiting the injection opening 87 for improved dispersion.

In an exemplary embodiment, the radius of curvature for the curved end portion 85 may also be defined by the desired injection opening size (see height H between upper and bottom inner edges 91 and 93, respectively, of the injection opening 87) when the bottom inner edge 93 of the injection opening 87 is substantially vertically aligned with the axis X. In the depicted exemplary embodiment, a smaller radius of curvature may be used to define a smaller injection opening height, and a larger radius of curvature may be used to define a taller injection opening height H. A taller height H generally corresponds to a longer arc length of the curved end portion 85, which as noted above, can improve the flow rate of the injection fluid exiting the injection opening 87. In an exemplary embodiment, the injection opening 87 has a height H extending between the bottom and top end of the injection opening of about 4 mm.

The injection opening 87 may be defined by cutting the tube after it is rolled with the selected radius of curvature. For instance, the injection opening 87 may be defined by cutting the tube at a 45° angle after it is rolled with the selected radius of curvature.

In an alternative embodiment, the cut into the rolled tube may be a curved cut having a radius of curvature. The radius of curvature of the tube cut may be selected or defined based on at least one of the following factors: (1) the radius of curvature of the curved end portion 85; (2) the size and shape of the injection opening 87 to direct injection fluid at a desired angle relative to the shank elongated center axis C; (3) the type of injection fluid being used; and (4) the type of food product being injected. Other factors may also be considered.

The tube may be cut in a suitable manner to define the injection opening 87 as well as any injection opening cutting face(s) 101 surrounding the injection opening 87 (extending between the shank interior sidewall 95 and a shank exterior surface or sidewall 97). In the example shown, the injection opening cutting face(s) 101 is defined by a first circumferential portion 103 defined by the initial cut into the tube at the predetermined angle or radius of curvature. In that regard, the first circumferential portion 103 initially extends around the entire circumference of the injection opening 87.

The injection opening cutting face(s) 101 may be further defined by a secondary beveled portion 105 beveled or cut into the first circumferential portion 103 near the bottom outer edge 89 of the needle tip 80. In that regard, the secondary beveled portion 105 extends around a circumferential section of the injection opening 87 near the bottom outer edge 89 of the needle tip 80. The secondary beveled portion 105 defines a vertical cutting face at the tip 80 of the needle 40 for effectively piercing a substrate when the needle is moved vertically downwardly. Although not shown, one or more additional beveled cuts may be used to define a portion of the injection opening cutting face(s) 101.

The injection opening cutting face(s) 101 may extend from the shank exterior sidewall 97 to the shank interior sidewall 95 at a predetermined angle, such as at an angle between about 25-45°. The predetermined angle of the injection opening cutting face(s) 101 may be defined at least in part by the radius of curvature of the tube cut and/or any additional beveling of the edges.

The secondary beveled portion 105 defines a plane having a vertical axis that is in a spaced parallel arrangement with the shank elongated center axis C. The secondary beveled portion 105 is spaced a predetermined distance from the shank elongated center axis C to define an arc length of the curved end portion 85. The curved end portion 85 has a suitable arc length to effectively shield the injection opening 87 and prevent food product from entering the opening.

In the depicted exemplary embodiment, the vertical plane of the secondary beveled portion 105 is spaced a predetermined distance from the shank elongated center axis C to locate the secondary beveled portion 105 in substantially vertical alignment with the elongated axis X of the shank interior sidewall 95. In this manner, the curved end portion 85 has a suitable arc length to effectively shield the injection opening 87 and prevent food product from entering the opening. More specifically, with the secondary beveled portion 105 in substantially vertical alignment with the elongated axis X, an exposed area EA of the injection opening 87 susceptible to plugging or coring is minimized.

As shown, the exposed area EA is defined by the horizontal gap defined between the secondary beveled portion 105 and the axis X of the shank interior sidewall 95. With the axis X and the secondary beveled portion 105 in substantial vertical alignment, the EA is essentially 0 mm. Accordingly, when the needle 40 is moved in a straight downward direction for injection, substantially no material from the food product enters the injection opening 87 in the exposed area EA. In other words, as noted above, the curved end portion 85 effectively shields the injection opening 87 from the food product.

Plugging and coring may also be reduced by using a substantially straight shank interior sidewall 95 opposite the curved end portion 85, as shown in FIG. 10. First, by using a substantially straight shank interior sidewall 95, the sidewall 95 is aligned with the axis X and the vertical plane of the secondary beveled portion 105, effectively defining an EA of 0 mm. In this manner, the curved end portion 85 effectively shields the injection opening 87 from the food product.

Second, by using a substantially straight shank interior sidewall 95 opposite the curved end portion 85, material is not proactively guided into the upper end of the injection opening 87 as the material of the food product passes over the opening. To better illustrate this concept, by comparison, the prior art rolled tip 80″ shown in FIG. 8 includes a slightly flared shank interior sidewall portion 96′ near the upper inner edge 91′ (opposite the curved end portion 85′″), which may be needed to accommodate the radius of curvature of the curved end portion 85′″ and/or the tube cut. The flared shank interior sidewall portion 96′ near the upper inner edge 91′″ can guide food product into the upper end of the injection opening 87′″ during insertion. By contrast, the substantially straight shank interior sidewall 95 opposite the curved end portion 85 of needle tip 80 does not guide food product into the upper end of the injection opening 87.

In addition to shielding the injection opening 87, the curved end portion 85 enables effective piercing and insertion of the needle tip 80 into a substrate. More specifically, both the bottom outer edge 89 and the vertical plane of the secondary beveled portion 105 are in substantially vertical alignment with the elongated axis X of the shank interior sidewall 95, which is slightly vertically offset from the shank elongated center axis C. As such, the bottom outer edge 89 and the secondary beveled portion 105 can substantially receive and transfer the needle carrier plunging force applied to the head 78 along the shank elongated center axis C. When moving vertically downwardly, the sharp point defined by the bottom outer edge 89 pierces the food product, and then the secondary beveled portion 105 smoothly slices through the product with its vertical cutting face.

In that regard, the needle 40 may be designed to penetrate the food product with a minimal amount of resistance, thus causing minimal disruption to product. The bottom outer edge 89 and the secondary beveled portion 105 may be sufficiently sharp to help minimize resistance. At the same time, the shank exterior sidewall 97 of the elongated hollow shank 70 may be polished and substantially free from burrs and roughness to help minimize resistance.

With the above-described features of the needle tip 80 in mind, the manner in which the needle tip 80 is used to inject a substantially hard food product like bacon and plant-based meats will now be described. Initially, a needle(s) 40 having the needle tip 80 is secured within a needle carrier, such as needle carrier 30 described above with respect to FIG. 1. Brine or another injection fluid filling the supply chamber 60 of the needle carrier 30 enters the needle 40 through inlet opening 82 (see FIG. 2). The needle 40 is then moved vertically downwardly toward a food product.

When moving vertically downwardly, the sharp point defined by the bottom outer edge 89 of the needle tip 80 pierces the food product, and then the tip 80 smoothly slices through the product with its vertical cutting face defined by the secondary beveled portion 105. As the tip 80 slices through the product, the injection opening 87 does not become plugged or cored with the product. Rather, the curved end portion 85 effectively shields the injection opening 87 and prevents food product from entering the opening.

Upon insertion, injection fluid travels down the hollow interior 86 of the elongated hollow shank 70 along the curved end portion 85. The injection fluid flows out of the injection opening 87 at the predetermined angle, guided by the curved path of the shank interior sidewall 95 along the curved end portion 85. In other words, the fluid flows out of the injection opening 87 at an angle relative to the shank elongated center axis C. The angle will depend on the type of fluid used (e.g., a more viscous fluid may flow out of the injection opening 87 at less of an angle compared to a less viscous, thicker fluid).

The injection fluid may also flow out of the injection opening 87 at a predetermined flow rate for optimal dispersion into the food product. For instance, with a smaller radius of curvature and extended length of the curved end portion 85 compared to the prior art design, the injection fluid may flow out of the injection opening 87 at a faster rate for improved dispersion. The flow rate will also depend on the type of fluid used (e.g., a more viscous fluid may flow out of the injection opening 87 faster than a less viscous, thicker fluid).

Based on the foregoing, it can be appreciated that the improved needle tip 80 directs injection fluid out of the injection opening for optimal dispersion into the food product while also substantially preventing plugging or coring at the injection opening. Moreover, by defining the injection opening 87 at the bottom of tip 80, the bottom portion of the food product, such as the bottom 6-7 mm, can be reached with injection fluid.

### EXAMPLE

Testing was performed to determine the effectiveness of injecting a food product with a brine solution using the improved needle tip described herein (“rolled tip hypodermic”) compared to a prior art needle design (“standard hypodermic”).

Test Equipment
IMAX injector
Rolled tip hypodermic needles (needles having a tip substantially identical to needle tip 80 shown and described herein)
Standard hypodermic needles
Boneless, trimmed, sirloin pork chops of generally the same size, shape, and thickness
Brine comprising salt, water, and blue dye

Test Procedures

A brine having the above-noted composition was prepared and placed in supply to the injector. The injector was loaded with the rolled tip hypodermic needles in the first part of the experiment, and the injector was loaded with the standard hypodermic needles in the second part of the experiment.

The injector settings (e.g., parameters that can be changed on injector) are set forth in Table 1 below. The first column in Table 1 indicates the strokes per minute of the injector, based on available settings of 1-9 strokes per minute (how many times the injector head goes up and down in a minute). The second column in Table 1 indicates the pressure used by the injector, in units of bar. The third column in Table 1, referencing the “stripper height”, indicates the setting on the injection head to define the gap between the bar that strips the needles out of meat and the injection bed. The fourth column in Table 1, referencing the “advance”, is based on a full or partial advance of the belt beneath the injector for every time it moves. The fifth column in Table 1 is the injection mode used, with the option in the case being a one-way spraying from the needles as they are moving down into the meat or a two-way spraying as the needles are moving down and also back up. The injector mode used was a one-way spraying.

TABLE 3
Injector Settings

| Strokes | Pressure | Stripper Height | Advance | Inject |
|---|---|---|---|---|
| 30 | 2.0 bar | 3^{rd} position | full | 20% |

The pork chops were placed onto a conveyor of the injector with a spacing and arrangement configured such that each pork chop would be injected in a substantially similar manner (e.g., injected using generally the same amount of needles).

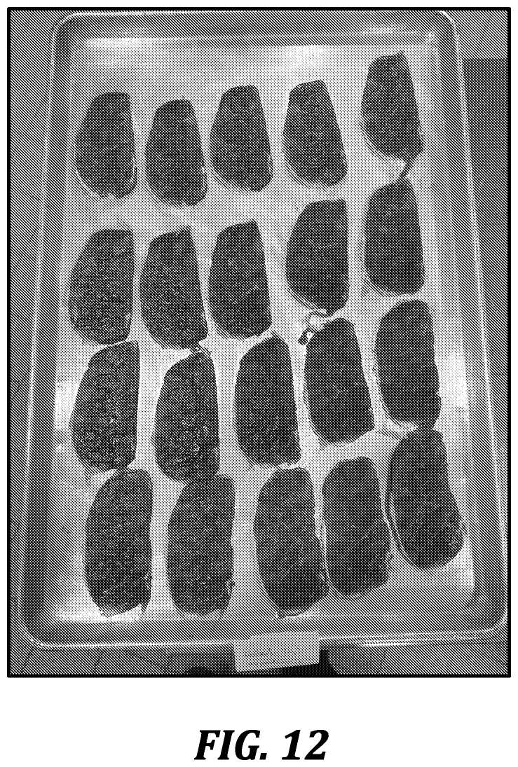

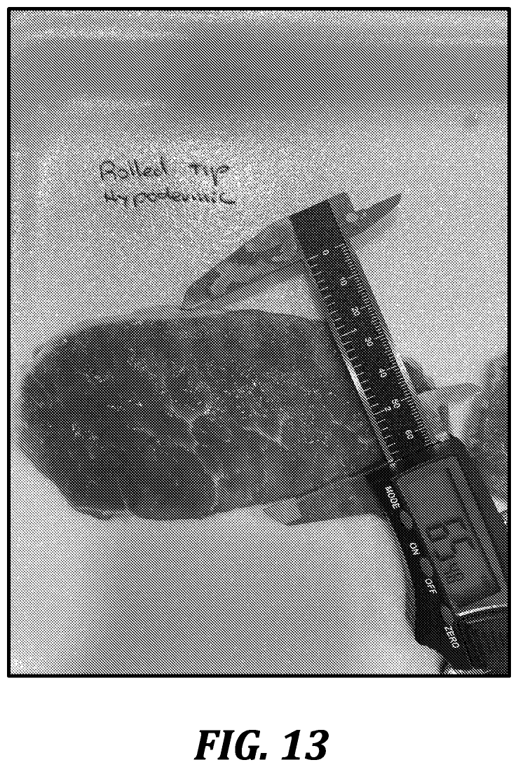

In the first part of the experiment, pork chops were injected using the rolled tip hypodermic needles. Images of the pork chops injected with the rolled tip hypodermic needles are shown in FIGS. 12 and 13. Dispersion of the brine within the pork chops can be seen in FIGS. 12 and 13 as the darkened areas of the pork chops.

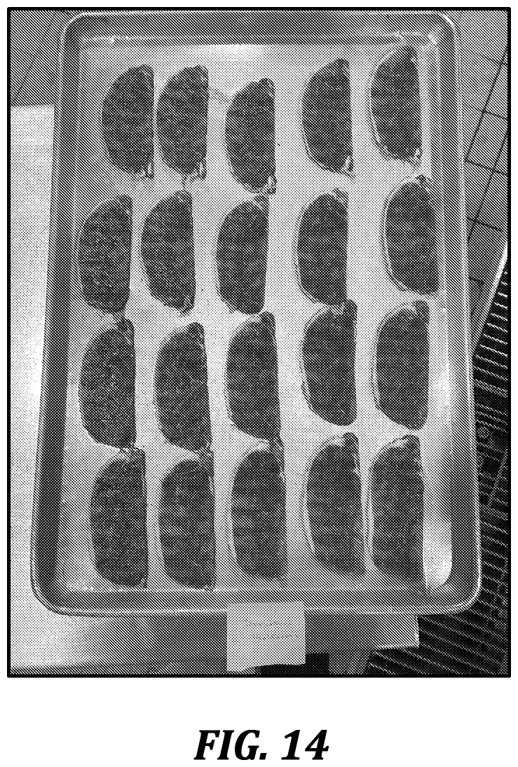

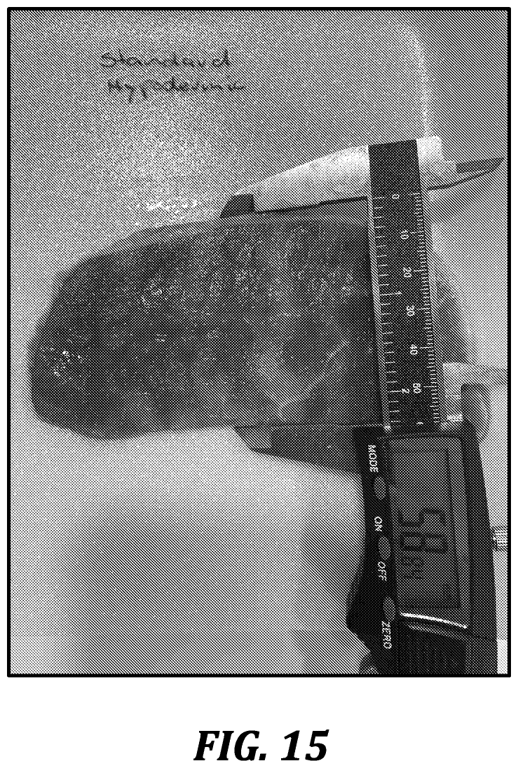

In the second part of the experiment, pork chops were injected using the standard hypodermic needles. Images of the pork chops injected with the standard hypodermic needles are shown in FIGS. 14 and 15. Dispersion of the brine within the pork chops can be seen in FIGS. 14 and 15 as the darkened areas of the pork chops.

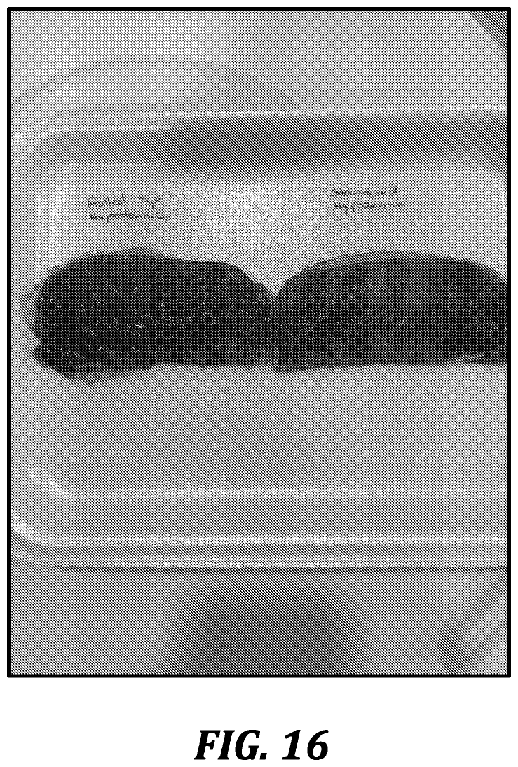

As can be seen by comparing FIGS. 12 and 13 (rolled tip hypodermic needle injected pork chops) to FIGS. 14 and 15 (standard hypodermic needle injected pork chops), the brine is more widely dispersed (or saturated with dye) in the rolled tip hypodermic needle injected pork chops. Specifically, the blue dye coverage area of the rolled tip hypodermic needle injected pork chops is greater than the blue dye coverage area of the pork chops injected with the standard hypodermic needle. For ease of comparison, FIG. 16 shows a rolled tip hypodermic needle injected pork chop next to a standard hypodermic needle injected pork chop.

Based on the foregoing, it can be appreciated that the improved needle tip 80 directs injection fluid out of the injection opening for optimal dispersion into the food product. The injection fluid is directed out of the improved needle tip 80 in a way that helps push fluid away from the needle, resulting in better fluid dispersion. In other words, when exiting the improved needle tip 80, the injection solution travels further within the food product as compared to using a standard hypodermic injection needle.

While illustrative embodiments have been illustrated and described, it will be appreciated that various changes can be made therein without departing from the spirit and scope of the invention.

1. An injection needle for injecting fluid into a substrate, comprising:
an elongated hollow shank having a center longitudinal axis, an inner shank wall, and an outer shank wall; and
a needle tip, comprising:
an injection opening; and
a curved end portion extending from the elongated hollow shank and having a radius of curvature, the curved end portion terminating distally in a bottom outer edge and a cutting face extending from the bottom outer edge toward the inner shank wall at a bottom end of the injection opening,
wherein the bottom outer edge and the cutting face are in substantially vertical alignment with an axis of a first portion of the inner shank wall extending from a top end of the injection opening.

2. The injection needle of claim 1, wherein the axis of the first portion of the inner shank wall is in a spaced parallel relationship with the center longitudinal axis of the elongated hollow shank.

3. The injection needle of claim 1, wherein the cutting face is in a spaced parallel relationship with the center longitudinal axis of the elongated hollow shank.

4. The injection needle of claim 1, wherein the curved end portion has a curvature of about 40°.

5. The injection needle of claim 4, wherein the injection opening has a height extending between the bottom and top end of the injection opening of about 4 mm.

6. The injection needle of claim 5, wherein a radius of curvature for the curved end portion may be defined such that fluid exiting the injection opening is at a substantially 40° angle relative to the shank elongated center axis C.

7. The injection needle of claim 6, wherein the injection opening is surrounded by an injection opening cutting face defined at least in part by a first circumferential portion surrounding the injection opening.

8. The injection needle of claim 7, wherein the injection opening cutting face is further defined by a secondary beveled portion cut into the first circumferential portion near the bottom outer edge of the needle tip.

9. The injection needle of claim 8, wherein the secondary beveled defines the cutting face.

10. A system for injecting fluid into a food product, comprising:
a needle carrier configured to receive injection fluid from a fluid source;
an injection needle received within the needle carrier, comprising:
an elongated hollow shank having a center longitudinal axis, an inner shank wall, and an outer shank wall; and
a head configured to receive a plunging force from the needle carrier; and
a needle tip, comprising:
an injection opening; and
a curved end portion extending from the elongated hollow shank and having a radius of curvature, the curved end portion terminating distally in a bottom outer edge and a cutting face extending from the bottom outer edge toward the inner shank wall at a bottom end of the injection opening,
wherein the bottom outer edge and the cutting face are in substantially vertical alignment with an axis of a first portion of the inner shank wall extending from a top end of the injection opening.

11. The system of claim 10, wherein the axis of the first portion of the inner shank wall is in a spaced parallel relationship with the center longitudinal axis of the elongated hollow shank.

12. The system of claim 10, wherein the cutting face is in a spaced parallel relationship with the center longitudinal axis of the elongated hollow shank.

13. The system of claim 10, wherein the curved end portion has a curvature of about 40°.

14. The system of claim 13, wherein the injection opening has a height extending between the bottom and top end of the injection opening of about 4 mm.

15. The system of claim 14, wherein a radius of curvature for the curved end portion may be defined such that fluid exiting the injection opening is at a substantially 40° angle relative to the shank elongated center axis C.

16. The system of claim 15, wherein the injection opening is surrounded by an injection opening cutting face defined at least in part by a first circumferential portion surrounding the injection opening.

17. The system of claim 16, wherein the injection opening cutting face is further defined by a secondary beveled portion cut into the first circumferential portion near the bottom outer edge of the needle tip.

18. The injection needle of claim 17, wherein the secondary beveled defines the cutting face.

19. The system of claim 10, wherein the elongated hollow shank has at least one inlet port being beveled or curved outwardly from the inner shank wall to an outer shank wall of the elongated hollow shank.
